(19) United States
(12) Patent Application Publication
(10) Pub. No.: US 2015/0353743 A1
(43) Pub. Date: Dec. 10, 2015

(54) ELECTROMAGNETIC ABSORBING COMPOSITION

(71) Applicant: BAE SYSTEMS PLC, London (GB)

(72) Inventors: JOSEPH MAURICE DAVIES, Bristol, South Gloucestershire (GB); SAJAD HAQ, Bristol, South Gloucestershire (GB); MICHAEL DUNLEAVY, Bristol, South Gloucestershire (GB); SIMON ROBERT CHURCH, Bristol, South Gloucestershire (GB)

(73) Assignee: BAE SYSTEMS PLC, London (GB)

(21) Appl. No.: 14/760,634

(22) PCT Filed: Jan. 13, 2014
(86) PCT No.: PCT/GB2014/050085

§ 371 Date: Jul. 13, 2015

(30) Foreign Application Priority Data
Jan. 14, 2013 (GB) 1300568.1

(51) Int. Cl. C09D 5/32; C09D 175/04; C09D 127/00; C09D 133/00

(52) U.S. Cl. CPC C09D 5/32; C09D 133/00; C09D 175/04; C09D 127/00; C08K 3/04

(57) ABSTRACT

EM field absorbing compositions, particularly lightweight magnetic and carbon loaded compositions. The composition finds particular use as a radar absorbing coating for structures. There are further provided coated surfaces comprising the composition, methods of absorbing EM radiation, and methods of use of such a composition, such that a surface coated in the composition is capable of absorbing EM radiation.

An electromagnetic radiation absorbing composition comprising an admixture of carbon nanotubes present in the range of from 0.1 to 10 v/v % dried, magnetic particulates with an average longest dimension of at least 1 micron, present in the range of from 1 to 60% v/v dried, in a non-conductive binder; preferably the iron particulates are present in the range of from 15-30% v/v.

The invention relates to EM field absorbing compositions, particularly lightweight iron and carbon loaded compositions. The composition finds particular use as a radar absorbing coating for structures. There are further provided coated surfaces comprising the composition, methods of absorbing EM radiation, and methods of use of such a composition, such that a surface coated in the composition is capable of absorbing EM radiation

According to a first aspect of the invention there is provided an electromagnetic radiation absorbing composition comprising an admixture of carbon nanotubes present in the range of from 0.1 to 10 v/v% dried, magnetic particulates with an average longest dimension of at least 1 micron, present in the range of from 1 to 60% v/v dried, in a non-conductive binder; preferably the magnetic particulates are present in the range of from 10 to 60% v/v, more preferably 15-50% v/v, yet more preferably 15 to 30% v/v.

Preferably the magnetic particulates are micron particulates with an average longest dimension in the range of 1 to 100 microns, preferably 1 to 50 microns. The particulates may be substantially spherical or high aspect ratio particulates, such as, for example a leaf or flake particulates.

The magnetic particulates may be any magnetic particulate, such as, for example iron, nickel and cobalt or magnetic alloys thereof.

The volume percentages are defined as a volume percentage of the final dried composition (i.e. without solvent). The composition may be dissolved in a solvent, such that said composition may be deposed to a surface, structure or body, in the form of a coating which may comprise at least one layer of said composition. It may be desirable to add sufficient solvent such that the composition may be applied to achieve the required final dried coating thickness in order to absorb at the frequency of the incident radiation. The composition may comprise a liquid formulation prior to application, and will preferably be in the form of a dried or cured coating after its application.

Preferably the carbon nanotubes are present in the range of 0.1 to 3% v/v, preferably 0.5 to 3% v/v. The carbon nanotubes have a length in the range of from 0.1 to 100 microns. The addition of less than 5% v/v carbon nanotubes has been shown to allow the magnetic particulate content to be reduced by a significant amount, with no loss in radar absorbance, thereby, allowing the magnetic particulates to only be present in the in the range of from 15-50% v/v, more preferably 15 to 25% v/v. The reduction of the % v/v of magnetic particulate content provides a significant weight saving, which may be of the order of several hundred kilograms for an application to a surface, structure or body which possess a large surface area to be covered.

The admixture of micron sized magnetic particulates and nano-sized carbon nanotube particulates allows only minimal point contact between the magnetic particulates and carbon nanotube particulates, such that the carbon nanotube particulates are non-magnetised carbon nanotube particulates. The carbon nanotube particulates are non-magnetic carbon nanotube particulates, such that they are not coated or layered with a magnetic material, instead the non-magnetised carbon nanotube particulates are simply mixed with the magnetic particulates.

The addition of the carbon nanotube particulates to a magnetic particulate loaded composition allows a means of providing a very low mass method of controlling the permittivity without affecting the permeability of the composition. If the carbon nanotubes were coated with a magnetic coating this would not be possible, as the permeability would also increase.

The non-conductive binder may be selected from any commercially available binder; preferably it may be selected from an acrylate binder (such as, for example, methyl methacrylate MMA), an acrylic binder, an epoxy binder, a urethane & epoxy-modified acrylic binder, a fluoro-elasomeric binder, a polysulphide binder, or a polyurethane binder, preferably a two part polyurethane binder.

The binders, thickeners and dispersion agents as routinely used in typical material formulations are not volatile and so will typically not be lost during the curing i.e. drying process. In contrast to the binders, the solvent that is added to aid deposition or application may evaporate during the drying process. A number of thickeners and solvents, such as, for example, those routinely used in material formulations, may be added to the composition in order to improve the flow during application and improve its adherence to different surfaces. Solvents may be organic such as, for example alkyl acetates, such as butyl acetate or aqueous media.

According to a further aspect of the invention there is provided the use of a composition as defined herein, wherein the composition is applied to a surface, structure or body or portions thereof at a selected thickness so as to provide a coating capable of absorbing electromagnetic radiation.

According to a further aspect of the invention there is provided a vehicle vessel or craft comprising at least one layer of composition as defined herein.

According to a yet further aspect of the invention there is provided a method of providing absorption of electromagnetic radiation on a surface structure or body or portions thereof, comprising the steps of applying at least one coat of composition as defined herein, to a first side of said surface structure or body or portions thereof, and optionally to a second side.

1. An electromagnetic radiation absorbing composition comprising an admixture of carbon nanotubes present in the range of from 0.1 to 10 v/v% dried, magnetic particulates with an average longest dimension of at least 1 micron and present in the range of 1 to 60% v/v dried, in a non-conductive binder.

2. A composition according to claim 1, wherein the carbon nanotubes are present in the range of 0.5 to 3% v/v.

3. A composition according to claim 1, wherein the magnetic particulates are present in the range of from 15 to 30% v/v.

4. A composition according to claim 1, wherein the composition further comprises one or more high shear thickeners, low shear thickeners, and dispersion additives.

5. A composition according to claim 1, wherein the binder is selected from an acrylate, an epoxy binder, an acrylic, a urethane & epoxy modified acrylic, a polyurethane, a fluoro-elastomer, and a polysulphide.

6. A composition according to claim 1, wherein the composition further comprises a solvent.

7. A surface, structure or body comprising at least one dried layer of a composition according to claim 1.

9. (canceled)

10. (canceled)

11. (canceled)

12. A vehicle vessel or craft comprising at least one layer of composition according to claim 1.

13. A method of using a composition, the composition comprising an admixture of carbon nanotubes present in the range of from 0.1 to 10 v/v % dried, magnetic particulates with an average longest dimension of at least 1 micron and present in the range of 1 to 60% v/v dried, in a non-conductive binder, wherein the method comprises applying the composition to a surface, structure or body or portions thereof to provide a coating capable of absorbing electromagnetic radiation.

14. A method according to claim 13, wherein the carbon nanotubes are present in the range of 0.5 to 3% v/v, and the magnetic particulates are present in the range of from 15 to 30% v/v.

15. A method according to claim 13, wherein the composition further comprises a solvent.

16. A method according to claim 13, wherein the composition further comprises one or more high shear thickeners, low shear thickeners, and dispersion additives.

17. A method according to claim 13, wherein the binder is selected from an acrylate, an epoxy binder, an acrylic, a urethane & epoxy modified acrylic, a polyurethane, a fluoro-elastomer, and a polysulphide.

18. A method according to claim 13, wherein the surface, structure or body or portions thereof are part of a vehicle vessel or craft.

19. A method of providing absorption of electromagnetic radiation on a surface structure or body or portions thereof, the method comprising applying at least one coat of a composition to a first side of said surface structure or body or portions thereof, and optionally to a second side, the composition comprising an admixture of carbon nanotubes present in the range of from 0.1 to 10 v/v% dried, magnetic particulates with an average longest dimension of at least 1 micron present in the range of from 1 to 60% v/v dried, in a non-conductive binder.

20. A method according to claim 19, wherein the carbon nanotubes are present in the range of 0.5 to 3% v/v.

21. A method according to claim 19, wherein the magnetic particulates are present in the range of from 15 to 30% v/v .

22. A method according to claim 19, wherein the composition further comprises a solvent.

23. A method according to claim 19, wherein the composition further comprises one or more high shear thickeners, low shear thickeners, and dispersion additives.

24. A method according to claim 19, wherein the binder is selected from an acrylate, an epoxy binder, an acrylic, a urethane & epoxy modified acrylic, a polyurethane, a fluoro-elastomer, and a polysulphide.
